(19) United States
(12) Patent Application Publication
(10) Pub. No.: US 2011/0315177 A1
(43) Pub. Date: Dec. 29, 2011

(54) MODIFIABLE WALKING-ASSISTANCE APPARATUS

(75) Inventors: Brian McGann, York Harbor, ME (US); Gregory Foweraker, Vancouver (CA); Shaye McGann, York Harbor, ME (US); Kate Dulac, Manchester, NH (US); Justin Aiello, Kennebunk, ME (US)

(73) Assignee: INTERCHANGEABLE MEDICAL WALKING STICKS LLC, York Harbor, ME (US)

(21) Appl. No.: 12/903,335

(22) Filed: Oct. 13, 2010

Related U.S. Application Data
(63) Continuation-in-part of application No. 12/198,223, filed on Aug. 26, 2008, now abandoned.
Application No. 12/198,223 is a continuation-in-part of application No. 12/198,296, filed on Aug. 26, 2008, now abandoned.

(51) Int. Cl. A61H 3/00

(52) U.S. Cl. 135/67

(57) ABSTRACT

A multifunctional apparatus for facilitating walking and a method of using the apparatus. The apparatus includes a plurality of pole members, a handle, at least a first grip member, and a second grip member, the first grip member is arranged to allow a user of the apparatus to move stably and the second grip member is arranged to allow a user of the apparatus to participate in a rigorous activity, and one or more ground contact members, The front pole members are connected through a connection member configured to allow the apparatus to be easily collapsed and/or disassembled. The grip members are removably connectable to the pole member at a first end of the pole member, and the one or more ground contact members are removably connectable to the pole member at a second end of the pole member. The method includes the steps of participating in one or more diagnostic activities by an individual to generate data and selecting one or more walking-improvement activities that involve use of the apparatus based on the data obtained.

### CROSS-REFERENCE TO RELATED APPLICATIONS

The present application is a continuation-in-part of and claims the priority benefit in, U.S. patent application Ser. No. 12/198,223, filed Aug. 26, 2008, entitled “MODIFIABLE WALKING-ASSISTANCE APPARATUS”, and U.S. patent application Ser. No. 12/198,296, filed Aug. 26, 2008, entitled “MULTIFUNCTIONAL WALKER APPARATUS”, both assigned to a common assignee. The entire contents of these prior applications are incorporated herein by reference.

### BACKGROUND OF THE INVENTION

1. Field of the Invention

The present invention relates to an apparatus to facilitate walking. More particularly, the present invention relates to an apparatus including a plurality of removably connectable parts, that alone or in combination may be used as a walker or other walking-assistive device, the form of which may be selected based upon the walking-assistive needs or interests of an individual. The present invention is also related to a method of using the apparatus to facilitate walking, such as for the purpose of improving the rehabilitation of an individual having a walking disorder or merely enhancing the physical ability of an individual.

2. Description of the Prior Art

Walking disorders are common. They are attributable to accidents, such as falls and collisions, for example, to maladies, such as vertigo, strokes and muscular degeneration, for example, and to surgery. Most walking disorders can be treated and, in many cases, complete recovery is possible. However, the rehabilitation process often is fraught with problems that must be overcome before such recovery can be made. For example, during the earliest stage of rehabilitation, the rehabilitating individual typically faces mental challenges that impede his/her ability to enjoy optimal progress. At this time, the individual may have little or no confidence that rehabilitation will be successful, and therefore, be worth enduring. When this is true, the individual may put forth little or no effort toward rehabilitation. As another example, the level of physical impairment of the individual can vary greatly throughout the rehabilitation process, which means that the rehabilitation process must be routinely monitored and adapted to best meet the rehabilitative needs of the individual. Some rehabilitating individuals, such as some stroke and motor vehicle crash victims, for example, suffer greatest impairment at the beginning of the rehabilitation process and then progressively improve until the rehabilitation process is completed. Walking impairment in other individuals, such as those inflicted with a muscular degenerative condition or who have naturally and progressively degenerated due to advanced age, for example, may be greatest at some time that is well after the impairment is first experienced. Further, some rehabilitating individuals may “have their good times and their bad times.” That is, their level of impairment may fluctuate widely in short swings throughout the rehabilitation process. For example, a rehabilitating individual may be able to walk without much assistance shortly before enduring a long bus trip, for example, and then need substantially more assistance just after the bus trip in order to walk.

Additionally, the rehabilitation process can be long and require that the individual undergoing rehabilitation use a plurality of walking-assistive devices at various points during the rehabilitation. For example, the multi-legged “walker” is a well known device for assisting the walking process. Walkers typically are used when the rehabilitating individual has a severe walking disorder and therefore is in need of significant assistance.

The cane is a well known tool used by individuals to assist them while walking. Canes provide stability for the individual beginning rehabilitation, the individual initiating an exercise regimen or the individual simply needing some form of support. For the rehabilitating individual, once that stability has been achieved, the support cane design is unsuitable for the move from rehabilitation to a more rigorous exercise regimen. On the other hand, a device such as a trekking stick is useful to the individual at the rigorous exercise stage of rehabilitation, but it offers little in the way of stability for the individual at the start of rehabilitation. That is, the trekking stick is less suitable as a stability device. Existing tools focus on one or the other of stability and exercise assistance, but these tools individually fail to be adjustable for the transition from initial rehabilitation to exercise.

No existing device combines all of the benefits and features of a walker, a cane and a trekking stick in a single unit. Therefore, some individuals who undergo rehabilitation for a walking disorder are forced to acquire separately a walker, a cane, and one or more trekking poles to assist them at various stages of their rehabilitation. Separately acquiring each of these can be extremely costly. Furthermore, requiring several different devices is inconvenient: at times an individual may feel weak or unwell and require a walker but only have a cane with them, or vice versa.

What is needed therefore is an improved apparatus for facilitating walking that is easily configurable into a variety of different arrangements by an individual as needed to meet any changes to the physical conditions of the individual over the course of increased physical ability, and to allow the individual to avoid having to acquire and transport multiple separate walking-assistive devices. The needed apparatus should be easily configurable into a variety of different arrangements by the individual as needed to meet any changes to the physical conditions of the individual over the course of increased physical ability and to allow the individual to avoid having to purchase and carry multiple walking-assistive devices. What is also needed is a method of using such an apparatus as part of a broader rehabilitation and/or wellness program.

### SUMMARY OF THE INVENTION

It is an object of the present invention to provide a multifunctional, modifiable walking-assistance apparatus that may be used, for example, by an individual undergoing rehabilitation, an individual whose walking ability is in decline due to advanced age, or an individual who needs stability while walking.

The apparatus includes a plurality of pole members, each one of which may be of adjustable length and may be formed by one or more shafts. Some or all of the pole members may be combined in several ways to form a walker, one or two canes, and/or one or two trekking sticks. When the apparatus is to be used as a walker, all poles are used, wherein one pair of the poles is connected together by a first side frame and a second pair of poles is connected together by a second side frame (in a four-pole configuration). In this arrangement, the four pole members are the legs of the walker. The walker form of the invention may be used by an individual who has great difficulty walking without substantial support.

The pole members may be of adjustable length and may be formed by a plurality of removably connectable shafts. Each pole member has an end that contacts an underlying substrate, such as the floor or the ground. Optionally, the substrate contacting end may be fixed or it may be a removable substrate contacting member.

One or more of the pole members can be disconnected from the side frames and can be used to form part of a walking-assistive device. Each such removable pole member has a grip receiving end opposite the substrate contacting end. The grip receiving end is capable of receiving a grip member. As such, the apparatus further includes at least a first grip member and a second grip member, wherein the first grip member is arranged for stability and the second grip member is arranged for more rigorous activity or to assist a user of the apparatus who wishes to increase his/her activity beyond normal walking, and one or more ground contact members. The grip member is removably connectable to a first end of the pole member, and the ground contact member may be removably connectable to a second end of the pole member. Each one of the grip member and the optional substrate contacting member is of selectable form. A removable pole member therefore may be in the form of a cane or a trekking pole, for example. The apparatus may be arranged in a variety of ways, and specifically may be arranged to best facilitate the needs of any individual who is to use the apparatus. For example, the apparatus may be arranged to facilitate walking, at various levels of rigorousness. When such a disconnected pole member is arranged as a cane, it may be used by an individual who has a walking disorder that is less severe than would require the walker apparatus. When the disconnected pole member is arranged as a trekking pole, it may be used by an individual who wishes support to facilitate rigorous walking.

Therefore, a particular individual who suffers a walking disorder, such as one arising in an automobile accident, for example, could use the present invention as a walker until she recovered sufficiently enough to be able to use the invention as a cane, and then, after using it as a cane, could use the invention as a trekking pole as she partakes in advanced, rigorous walking exercise. In other words, the individual could use the present invention throughout her rehabilitation program: from the early stages when she is in need of greatest assistance, to the late stages when her walking ability has substantially recovered. Use of a single device throughout all stages of rehabilitation is financially advantageous and much more convenient than acquiring separate devices.

It is another object of the present invention to provide a method for using the present apparatus as part of a rehabilitation or wellness program. The method generally includes the steps of: (a) participating in one or more diagnostic activities by a health care professional of the individual; (b) monitoring the one or more diagnostic activities to obtain data; (c) using the data to select one or more walking-assistive activities; and (d) participating in the selected one or more walking-assistive activities by the individual, wherein the one or more locomotion-assistive activities are selected based on the data, and wherein the participation in the selected one or more walking-assistive activities includes the use of the apparatus.

The method may be carried out for a variety of purposes. For example, the method may be carried out for the purpose of facilitating the rehabilitation process of an individual who is inflicted with a walking disorder, which may occur, for example, as a result of surgery. As another example, the method may be carried out for the purpose of improving the overall wellness of an individual who is free of any walking disorder but may benefit by using the apparatus, such as for the purpose of gaining stability, for example. As yet another example, the method may be carried out for the purpose of facilitating the rehabilitation process and improving the overall fitness of an individual who is inflicted with a walking disorder. Use of a multifunctional walking apparatus in such a method is financially advantageous for the user, and may contribute to better outcomes by allowing a more comprehensive rehabilitation scheme to be pursued in a system of wellness. A multifunctional walking apparatus also provides advantages to the physical therapist or medical professional in charge of the rehabilitation process: the patient will feel more in control of each stage of the process and is consequently more likely to complete the wellness program. These and other advantages of the present invention will become apparent upon review of the following detailed description, the accompanying drawings and the appended claims.

### BRIEF DESCRIPTION OF THE DRAWINGS

FIG. 1 is a perspective view of a first embodiment of the walker apparatus of the present invention, wherein the apparatus includes a plurality of pole members and a plurality of side frame members.

FIG. 2 is a front perspective view of a second embodiment of the walker apparatus of the present invention.

FIG. 3 is a top perspective view of the walker apparatus shown in FIG. 2.

FIG. 4 is an exploded view of the walker apparatus shown in FIGS. 2 and 3.

FIG. 5 is a perspective view of the walker apparatus shown in FIG. 2 folded for storage or transportation.

FIG. 6 is a rear perspective view of a portion of the walker apparatus shown in FIG. 2 with the two rear legs detached from the walker.

FIG. 7 is a perspective view of one of the pole members of the apparatus.

FIG. 8 is a perspective view of one of the side frame members of the apparatus.

FIG. 9 is an exploded side view of an embodiment of a walking-assistive device of the apparatus of the present invention with an embodiment of the first grip member.

FIG. 10 is a side view of the components of the device of FIG. 9 joined together.

FIG. 11 is a close-up cross-sectional view of the interface between a grip member and a pole member of the apparatus.

FIG. 12 is an exploded side view of a pole member of the invention.

FIG. 13 is a side view of the components of the pole member of FIG. 12 joined together.

FIG. 14 is a side view of an embodiment of the second grip member of the present apparatus.

FIG. 15 is a side view of the FIG. 14 embodiment of the second grip member of the present apparatus removably connected to the pole member.

FIG. 16A is a side view of an embodiment of the first grip member of the present apparatus.

FIG. 16B is a side view of an alternative embodiment of the first grip member of the present apparatus.

FIG. 17 is a side view of a first embodiment of an optional ground contact member of the present apparatus.

FIG. 18 is a side view of a second embodiment of an optional ground contact member of the present apparatus.

FIG. 19 is a side view of a third embodiment of an optional ground contact member of the present apparatus.

FIG. 20 is a flow diagram showing the steps of a method of using the apparatus of the present invention.

### DETAILED DESCRIPTION OF THE PREFERRED EMBODIMENT

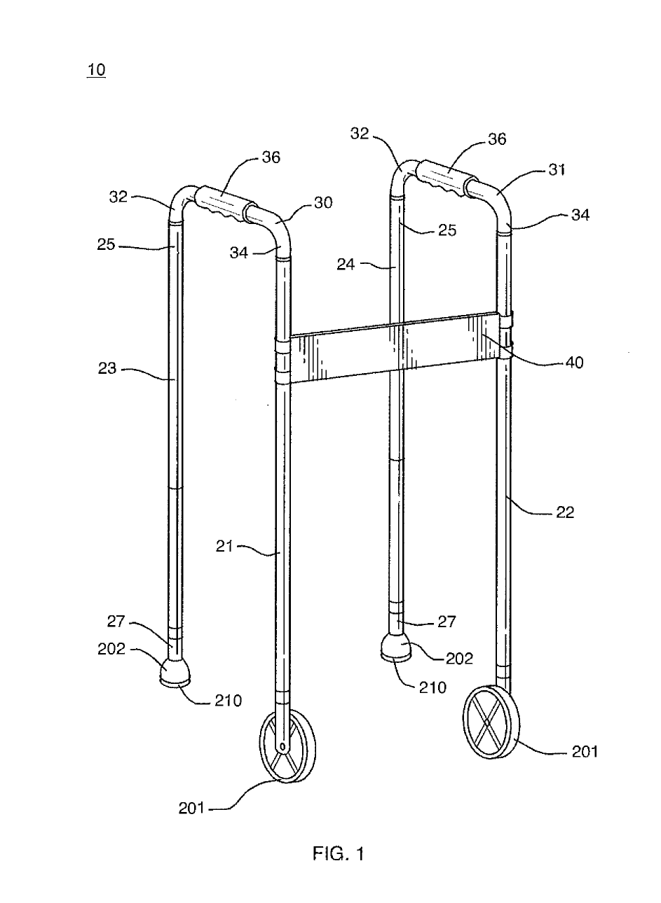

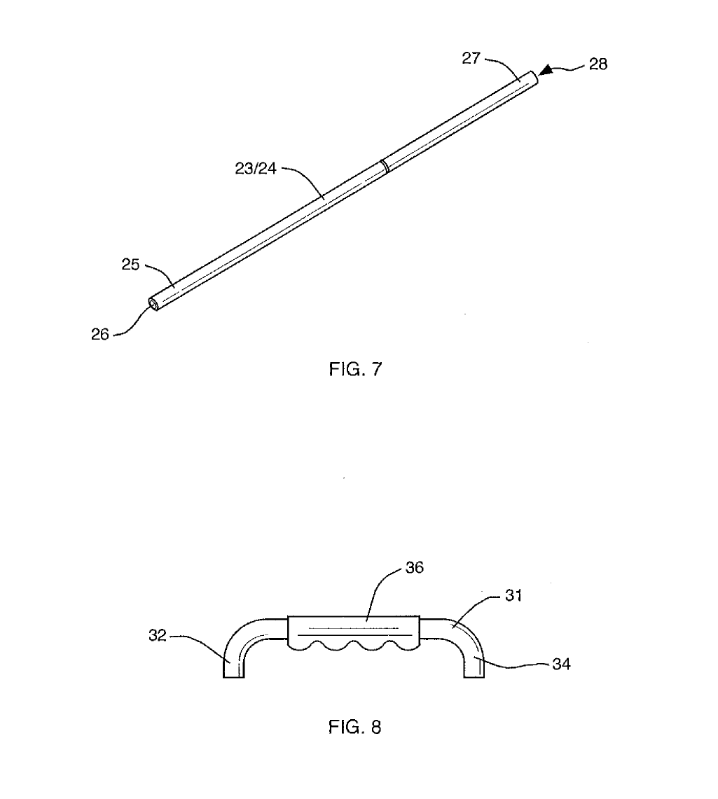

The present invention is a multifunctional, modifiable walking-assistance apparatus arranged to assist an individual to walk under a variety of conditions. The present invention is also a method to improve wellness, including the use of a modifiable walking- assistance apparatus. As shown in FIG. 1, the apparatus 10 is a walker that includes four pole members, comprising front pole members 21 and 22, and rear pole members 23 and 24. The apparatus 10 further includes first side frame member 30, second side frame member 31 and front connection member 40. The front connection member 40 operates as means to removably connect the front pole members 21/22 together. Each rear pole member 23/24 has a first end 25 having an optional opening 26 (shown in FIG. 7) and a second end 27 having an optional opening 28 (shown in FIG. 7). Further, each side frame member 30/31 has a first end 32 and a second end 34. Each of first end 32 and second end 34 of the side frame member 30/31 is capable of being removably connected to the first end 25 of the corresponding one of the rear pole members 23/24. Each one of the front pole members 21/22 is either integrally formed with, or is removably connectable to, a corresponding one of the side frame members 30/31. Further, the front connection member 40 is either integrally formed with, or removably connectable to, the front pole members 21/22 and serves to help establish the overall support frame for walking and to maintain the structural integrity of the apparatus 10.

The apparatus 10 also includes a substrate contacting or ground contact member for each pole member. For example, the ground contact member may be a wheel 201, including the two wheels 201 shown in FIG. 1 that are connected to corresponding ones of the front pole members 21 and 22. The wheels 201 may be fixedly or removably connected to the front pole members 21 and 22. Alternatively, the front pole members 21 and 22 may have some other form of substrate contacting arrangement. One such alternative is a footing 202, such as that shown connected to the rear pole members 23 and 24 in FIG. 1. Each footing 202 has a ground contact region 210, which may be a surface gripping ground contact region. The ground contact member may be fixedly or removably connected to the rear pole members 23 and 24. Alternatively, the rear pole members 23 and 24 may have some other form of substrate contacting arrangement. Further and as noted, the footings 202 may alternatively be used to replace the wheels 201 on the first pole members 21 and 22. In the embodiment of the invention shown in FIG. 1, the apparatus 10 therefore may include two wheels 201 and two footings 202. The parts of the apparatus 10 that are configured into the frame of the walker can be made of any suitable material, including, but not limited to, aluminum.

In the walker arrangement shown in FIG. 1, a user may use the apparatus 10 by gripping either or both of the side members 30 and 31 by handle 36 and moving the apparatus 10 along an underlying surface by the two wheels 201 while slightly raising the footings 202 from the underlying surface, or at least moving the ground contact members along the underlying surface. The apparatus 10 is arranged to provide sufficient support under the conditions typically expected for a traditional walker.

The apparatus 10 preferably is sturdy and lightweight and may be formed from any one or more of a variety of materials. Materials from which the apparatus 10 may be formed therefore include, but are not limited to, for example, aluminum, titanium, stainless steel, carbon fiber, graphite, fiberglass, other nonmetallic materials and any combination thereof.

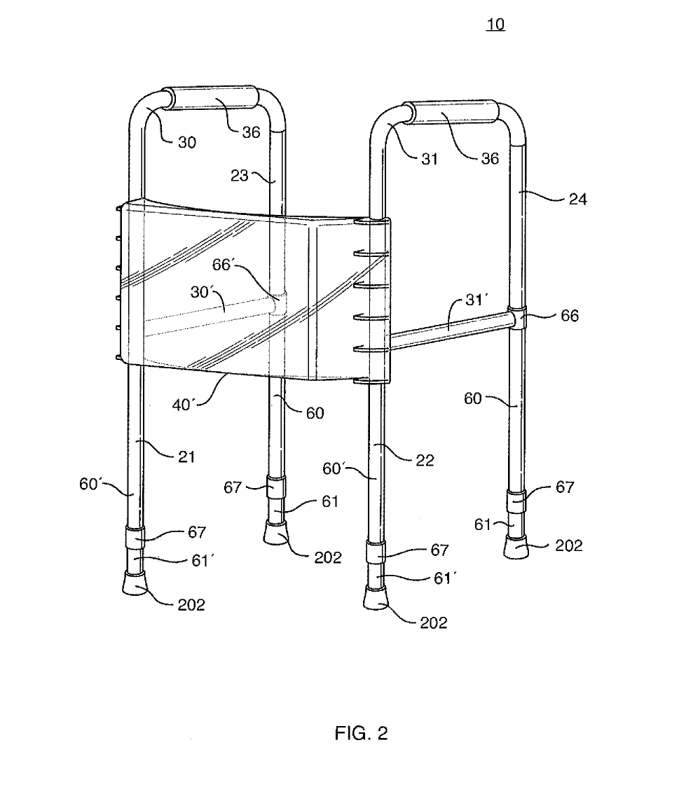

FIG. 2 illustrates a second embodiment of the apparatus 10. In FIG. 2, all four ground contact members are footings 202 rather than wheels 201. In addition, the front pole members 21 and 22 are integrally formed with the side frame members 30/31. Additional side frame members 30′ and 31′ are present lower down on apparatus 10 connecting the rear pole members 23/24 and front pole members 21/22 in order to provide increased support. The rear pole members 23/24 are connected to the side frame members 30′,31′ through rear leg holders 66/66′. The length of the front pole members 21/22 and rear pole members 23/24 is adjustable in the embodiment shown in FIG. 2, which may be achieved by adjusting the connection point between, for example, the rear pole member 23/24 and the ground contact member 202. Alternatively, the length adjustment may be achieved by configuring the pole members 21-24 as a plurality of shafts that facilitate such adjustability. FIG. 2 illustrates this telescoping shaft model, where the front pole members 21/22 are formed of two parts, an upper shaft 60′ and a lower shaft 61′ and the rear pole members 23/24 are formed by two parts, an upper shaft 60 and a lower shaft 61. The lower shaft 61/61′ may be adjustably, securably and removably retained within a portion of the upper shaft 60/60′, or the upper shaft 60/60′ may be adjustably, securably and removably retained within a portion of the lower shaft 61/61′. The connection between the upper shaft 60/60′ and lower shaft may be 61/61′ may be covered by a rubber joiner 67 in order to cover rough edges.

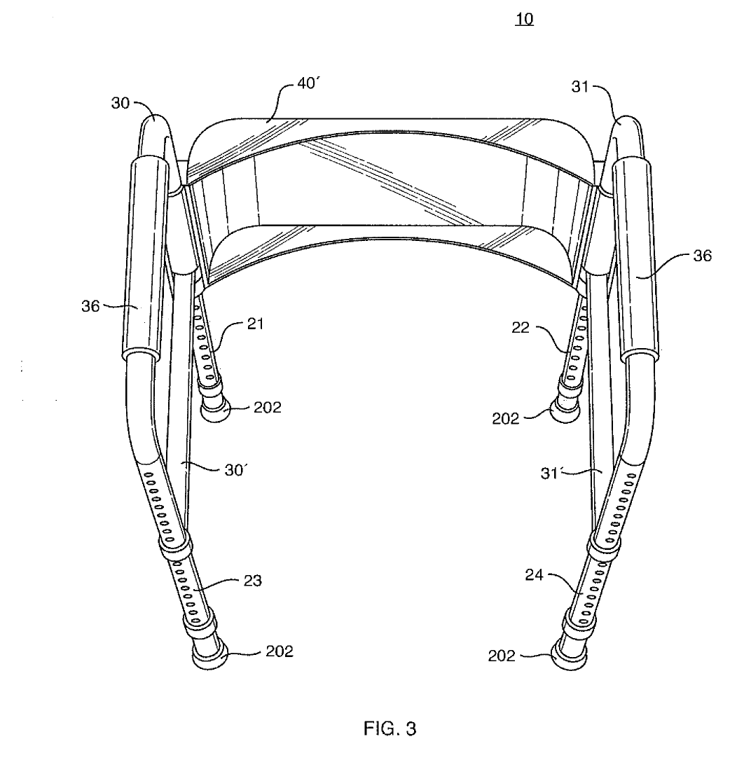

In the embodiment of apparatus 10 shown in FIG. 2, the front connection member 40′ is made out of a clear material. A suitable but nonlimiting example of a clear material that can be used as the front connection member 40′ is a polycarbonate resin thermoplastic such as LEXAN™. Those skilled in the art can readily envisage other suitable clear materials for use as the front connection member 40′. Constructing the front connection member 40′ out of a clear material provides several advantages to the user of the apparatus 10. FIG. 3 provides a user view of the apparatus 10 with a clear front connection member 40′. As is apparent, use of a clear front connection member 40′ provides a better view to a user, allowing maximum visibility. Increased visibility is important to optimize the safety of a user of the apparatus 10, since users of the apparatus 10 are likely to suffer from balance problems and could easily fall if the apparatus 10 was to strike or run against an unseen object on the ground. In addition, the apparatus 10 feels less confining to users with a clear front connection member 40′. Feeling less confined may help users to overcome the mental challenges a rehabilitating individual typically faces that impede his/her ability to enjoy optimal progress and improve confidence in using the apparatus 10 and that rehabilitation may be successful. As such, the apparatus 10 with a clear front connection member 40′ may be particularly useful in the method of the present invention.

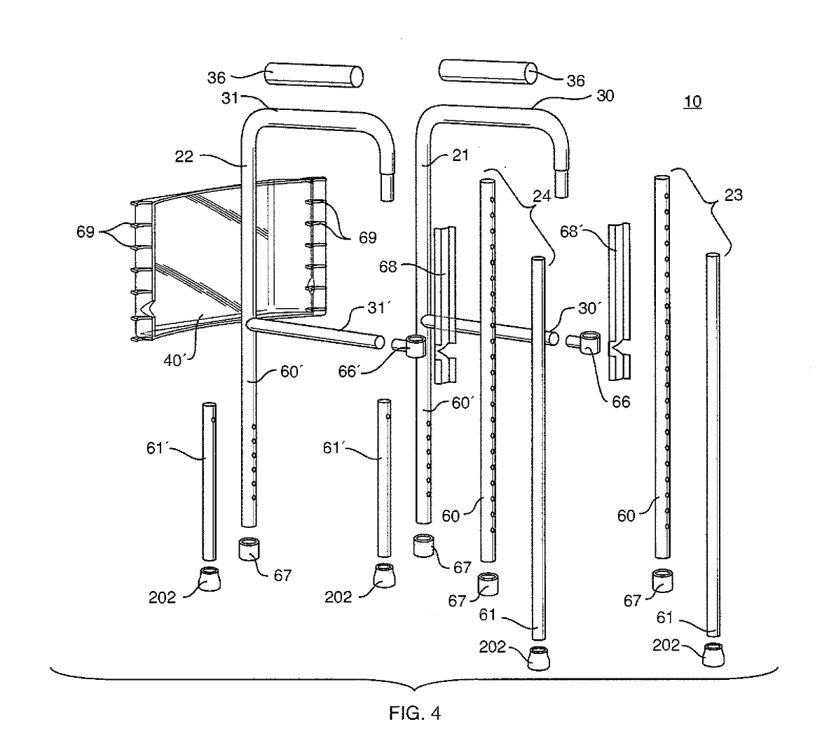

FIG. 4, an exploded view of the apparatus 10 of FIG. 2, illustrates one example of how the clear front connection member 40′ may be connected to the apparatus 10. As can be seen, mounting plates 68/68′fit onto the front pole members 21/22. Mounting plates 68/68′ include recesses to fit around side frame members 30′/31′. The front connection member 40′ is configured so that each end fits over the mounting plates 68/68′ and thus is in contact with a substantial portion of the front pole members, improving the stability of the apparatus 10. In the embodiment depicted in FIG. 4, the front connection member 40′ includes ribs 69 built into the area that slide over the mounting plates 68/68′. Friction fit or pressure connections such as depicted in this embodiment of the apparatus 10 are advantageous because they allow a user to easily disassemble the apparatus 10 if necessary, contributing to the advantages of the apparatus 10 over similar devices known in the art. Regardless, those skilled in the art can easily envisage other suitable types of removable connections, and the present invention is not limited hereto.

Because the apparatus 10 of the present invention includes a plurality of removably connectable parts, whenever a part, such as the ground contact member 202, for example, becomes worn or otherwise defective, the user of the apparatus 10 may replace only that defective part without having to replace the entire apparatus 10. Therefore, the apparatus 10 is cost-effective. The ability to remove parts also is convenient to the user because this capability allows the user the option of carrying around certain spare parts, and therefore not an entire spare apparatus, for when these parts become defective.

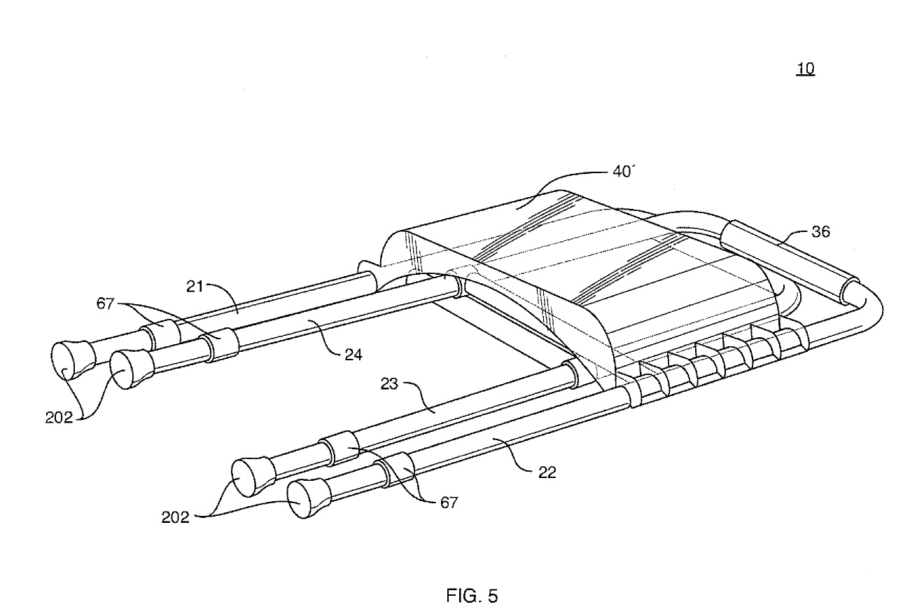

Furthermore, because the apparatus 10 includes a plurality of removably connectable parts and the length of the pole members 21/22, 23/24 optionally may be slidably adjustable, the apparatus 10 of the present invention is easy to transport. FIG. 5 illustrates how this embodiment of the apparatus 10 can be easily collapsed for transportation or storage. The pressure connection between the ribs 69 of front connection member 40′ and the mounting plates 68/68′ is configured to allow the apparatus 10 to be collapsed as shown in FIG. 5 without taking the components apart. Alternatively, the apparatus 10 may be easily and quickly disassembled and/or the length of the pole members 21/22, 23/24 may be slidably reduced, such as when the apparatus 10 is to be stored in the overhead compartment of a commercial airplane, for example, for later reassembly (if necessary) and use. To further enhance the transportability of the apparatus 10, the apparatus 10 may include an optional storage container, such as a rigid plastic case or a soft canvas bag, for example, for carrying all or some of the parts of the apparatus 10.

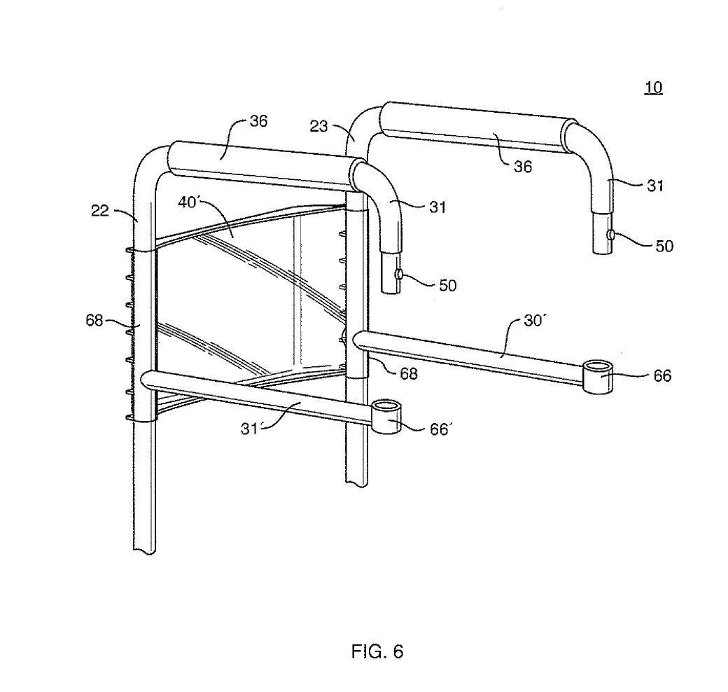

Designing the apparatus 10 to come apart easily into parts serves additional advantages beyond ease of transportation and storage. Users can easily convert apparatus 10 into alternative walking-assistive devices 15 such as a cane or a walking stick. FIG. 6 illustrates the apparatus 10 with the rear legs removed. In this embodiment, side frame members 30/31 each contain a depressible spring pin 50 which holds the rear pole members 23/24 in place together with the rear leg holders 66/66′ when assembled to form apparatus 10. FIG. 7 illustrates one of rear pole members 23/24 separated from the apparatus 10 as it would be when being arranged in the form of a walking-assistive device, and FIG. 8 illustrates side frame member 31 with first end 32 and a second end 34 separated from the apparatus 10. Each of first end 32 and second end 34 of the side frame member 30/31 is capable of being removably connected to the first end 25 of the corresponding one of the rear pole members 23/24 shown in FIG. 7 for assembling the apparatus 10.

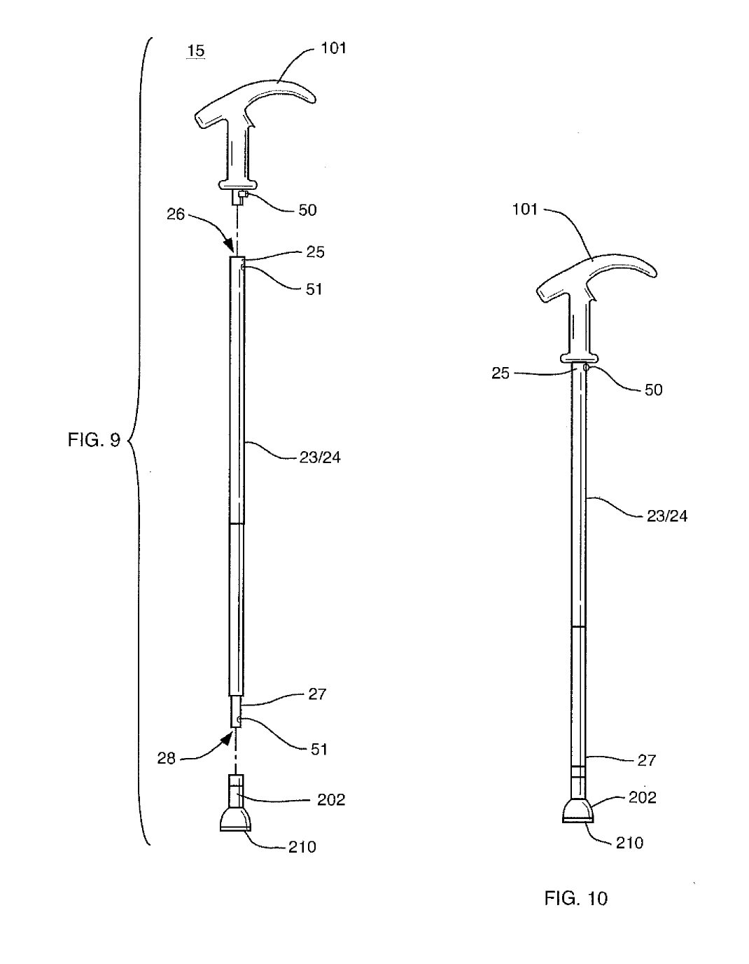

A portion of the apparatus 10 may be converted into a walking-assistive device 15 such as the walking-assistive device 15 shown in FIGS. 9 and 10. A first grip member 101 is removably connectable to the first end 25 of the pole member 23/24, and the ground contact member 202 is removably connectable to the second end 27 of the pole member 23/24. As can be seen in FIG. 9, opening 26 of first end 25 of the rear pole member 23/24 is capable of receiving a grip member, such as, but not limited to, the first grip member 101. Optionally, the second end 27 of the rear pole member 23/24 is capable of removable placement into the ground contact member, such as, but not limited to, the footing 202 having surface gripping ground contact region 210. Alternatively, footing 202 may be permanently affixed to the rear pole member 23/24 at second end 27.

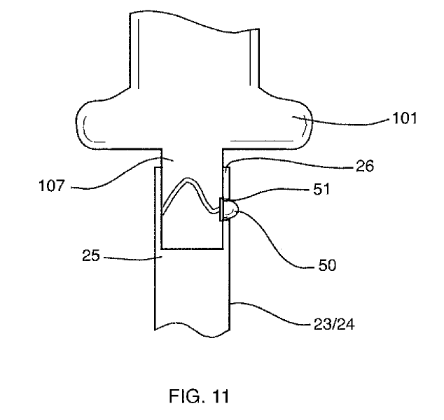

The skilled artisan will recognize that there are a large variety of options for connecting the first grip member 101 and the ground contact member such as footing 202 to the rear pole member 23/24 in a removable or detachable way. For example, the first grip member 101 may include a depressible spring pin 50 as shown in FIG. 11, and the first end 25 of the rear pole member 23/24 may include one or more selectable openings 51 for removably retaining the depressible pin 50 therein. Alternatively, the first end 25 of the rear pole member 23/24 may include a depressible spring pin and the first grip member 101 may include one or more selectable openings for removably retaining the depressible spring pin therein.

In the version represented in FIG. 11, the first grip member 101 may be secured within pole member 23/24 by depressing the depressible spring pin 50 located on leg 107 of the first grip member 101, inserting the leg 107 of the first grip member 102 into opening 26 of the first end 25 of the rear pole member 23/24 and releasing the depressible spring pin 50. The leg 107 of the first grip member 101 is pressed into the opening 26 until the depressible spring pin 50 reaches a selectable one of the openings 51 for fitting therein and releasably locking the first grip member 101 to the rear pole member 23/24. It is to be understood, however, that in some embodiments of the invention, the pole member 23/24 includes the pin 50 and the first grip member 101 includes the opening 51 for releasable engagement with the pin 50. It is also to be understood that, in some embodiments of the invention, the optionally removable ground contact member is connectable to second end 27 of the pole member 23/24 by including either one of these two arrangements of the depressible spring pin 50 and opening 51 as part of the ground contact member and second end 27 of the rear pole member 23/24.

As another example of the invention in which a subset of the primary components of the apparatus 10 may be removably connected together, the grip member, such as the first grip member 101 and/or the ground contact member, such as footing 202, may be removably connected to the rear pole member 23/24 by friction fit. That is, the leg 107 of the first grip member 101, for example, may be slidably fit into, and snuggly held in, opening 26 of the first end 25 of the rear pole member 23/24. As yet another example, the first grip member 101 may include male threading or a female threaded opening and the first end 25 of the rear pole member 23/24 may include corresponding compatible female/male threading for rotatable insertion and removable connection of the first grip member 101 and the rear pole member 23/24. It is to be understood, however, that the invention is not limited only to these examples of the removable connectability of any of the grip member designs described herein and/or any of the ground contact member designs described herein to either or both of the rear pole members 23 and 24.

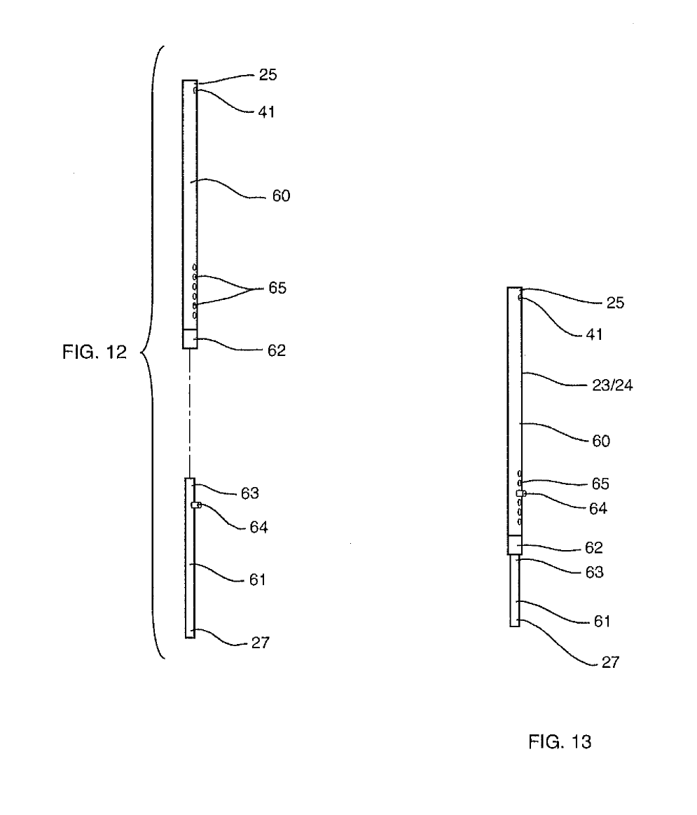

As mentioned above, the length of the pole member 23/24 may be fixed, such as would be the case when the pole member 23/24 is a single component, or the length of the pole member 23/24 may be adjustable. When the length of the pole member 23/24 is to be adjustable, this may be achieved by adjusting the connection point between the pole member 23/24 and the grip member, and/or between the pole member 23/24 and the ground contact member. Alternatively, the length adjustment may be achieved by configuring the pole member 23/24 as a plurality of shafts that facilitate such adjustability. In one example, shown in FIGS. 12 and 13, the pole member 23/24 is formed by an upper shaft 60 and a lower shaft 61. The lower shaft 61 may be adjustably, securably and removably retained within a portion of the upper shaft 60, such as is shown in FIG. 13, or the upper shaft 60 may be adjustably, securably and removably retained within a portion of the lower shaft 61. (This latter arrangement of the upper shaft 60 within the lower shaft 61 is not shown).

The ability to adjust the upper shaft 60 with respect to the lower shaft 61, secure the upper shaft 60 to the lower shaft 61 and allow for the complete removal of the upper shaft 60 from the lower shaft 61 may be achieved, for example, by including a depressible pin 64 at or near either of lower end 62 of upper shaft 60 and upper end 63 of lower shaft 61, and a plurality of openings 65 at or near lower end 62 of upper shaft 60 or upper end 63 of lower shaft 61. When the pin 64 and the openings 65 are included as corresponding parts of the shafts 60 and 61, one may be slidably, removably and securably connected to a portion of the other by inserting the pin 64 into any one of the openings 65 to be selected based upon the desired length of the pole member. It is to be understood, however, that the invention is not limited to having this pin 64 and plurality of openings 65 arrangement to achieve the modifiable connectability of the shafts 60 and 61 for the purpose of pole member length adjustability. The skilled artisan will recognize that there are a variety of other ways this connection may be achieved.

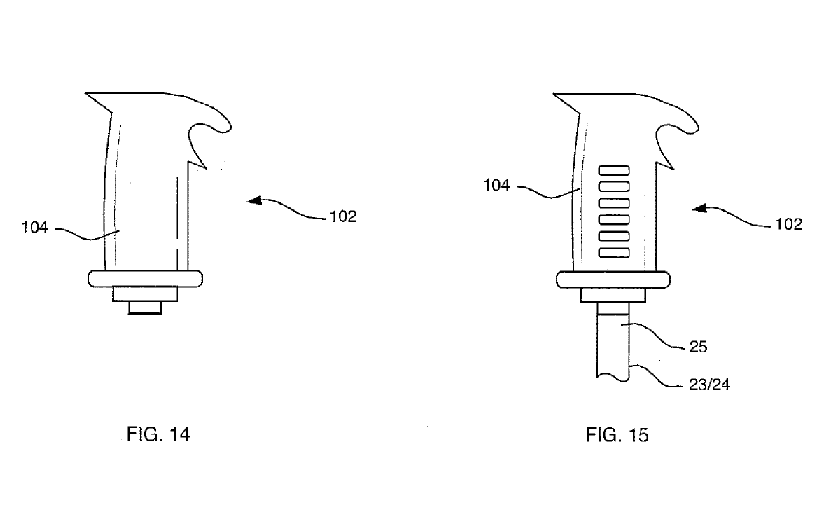

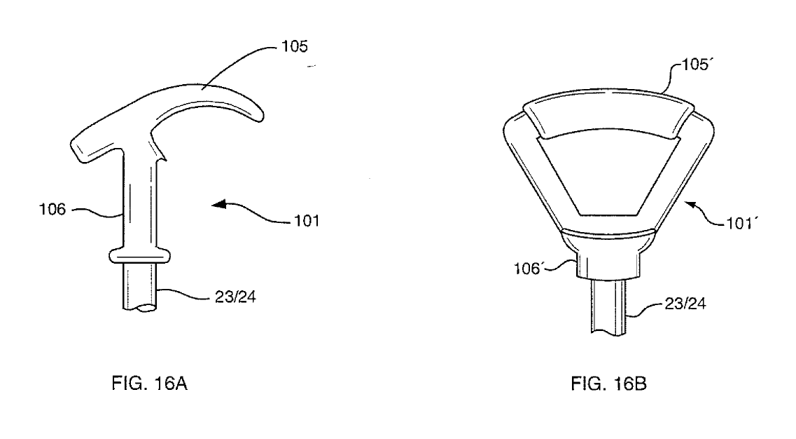

The first grip member 101 may be in any one of a plurality of forms and it may be in any one of a plurality of connection arrangements with respect to the rear pole member 23/24 when the first grip member 101 is removably connected to one of the rear pole members 23/24 as shown in FIG. 9. In that embodiment, the grip region 105 (see FIG. 16A) is angled at about 90° with respect to the longitudinal axis of the rear pole member 23/24. An embodiment of a second grip member 102 is substantially in the form shown in FIG. 14. When the second grip member 102 is used in forming the walking-assistive device 15, grip region 104 may be substantially axially aligned with respect to the longitudinal axis of rear pole member 23/24, such as shown in FIG. 15, for example. The skilled artisan will recognize that any relatively upright arrangement of the grip region 104 with respect to the rear pole member 23/24 will allow a user of the walking-assistive device 15 to participate in a rigorous activity, such as fast-paced walking, for example, while gripping the rear pole member 23/24 of the device 15.

However, it is to be understood that when the second grip member 102 is removably connected to the apparatus 15, the grip region 104 may be less than substantially axially aligned with respect to the longitudinal axis of rear pole member 23/24. For example, the grip region 104 may be angled by as much as about 45° or as little as about 10° less than axial with respect to the pole member 23/24. The skilled artisan will recognize that any relatively upright arrangement of the grip region 104 with respect to the pole member 23/24 will allow a user of the apparatus 15 to participate in a rigorous activity, such as fast-paced walking, for example, while gripping the pole member 23/24 of the apparatus 15.

FIGS. 16A and 1613 illustrate two different embodiments of the first grip member 101/101′. In FIG. 16A the grip region 105 and grip body 106 are configured in the form of a traditional cane handle. In FIG. 16B, the grip region 105′ is supported on either side by grip body 106′, contributing to the stability of the walking-assistive device 15 when assembled with a first grip member 101′. When the first grip member 101/101′ is removably connected to the rear pole member 23/24, grip region 105/105′ may be substantially at a right angle with respect to the axis of the rear pole member 23/24, while grip body 106/106′ is substantially axially aligned with the rear pole member 23/24. However, it is to be understood that when the first grip member 101/101′ is removably connected to the rear pole member 23/24, the grip region 105/105′ may be at an angle with respect to the rear pole member 23/24 that is somewhat different than a right angle, but at least sufficiently angled to permit the user to use the walking-assistive device 15 as a stabilizing structure, such as a cane, rather than as a rigorous exercise device. That is, the skilled artisan will recognize that any relatively right-angled arrangement of the grip region 105/105′ with respect to the rear pole member 23/24 will allow a user of the walking-assistive device 15 to participate in a moderate activity, such as slow, steady and stable walking on a flat indoor surface, for example, while gripping the first grip member 101/101′ when removably affixed to the rear pole member 23/24.

Either of the embodiments of the grip member of the present invention is designed for easy and comfortable gripping by a human hand. Therefore, the grip region 104/105 may include or may be formed as a soft covering, and/or is textured or otherwise formed, for improved gripping. Suitable soft materials include, but are not limited to, rubber, foam, and plastic, for example. As will be recognized by the skilled artisan, the grip member also may be in any one of a variety of shapes and be in any one of a variety sizes. The grip member may be shaped and/or sized to accommodate a variety of hand sizes, such as the small hands of a child or the large hands of an adult, for example. The grip member also may be shaped and/or sized to meet the needs of an individual having a particular hand disability, such as arthritis, for example, that prevents the individual from gripping the grip member completely or otherwise normally.

Further, because it is recognized that an individual who is missing one or both hands would benefit from the present invention, the grip member may be formed such as to allow secure gripping by a prosthetic device that does not include a human hand-like clasping member, such as a prosthetic device that includes a clip-like or tripod-like clasping member, for example. Therefore, the grip region 104/105 of the grip member may be formed from a rigid material, such as stainless steel, for example, to allow it to withstand being gripped by a durable clasping member, such as one that is also formed from stainless steel, for example.

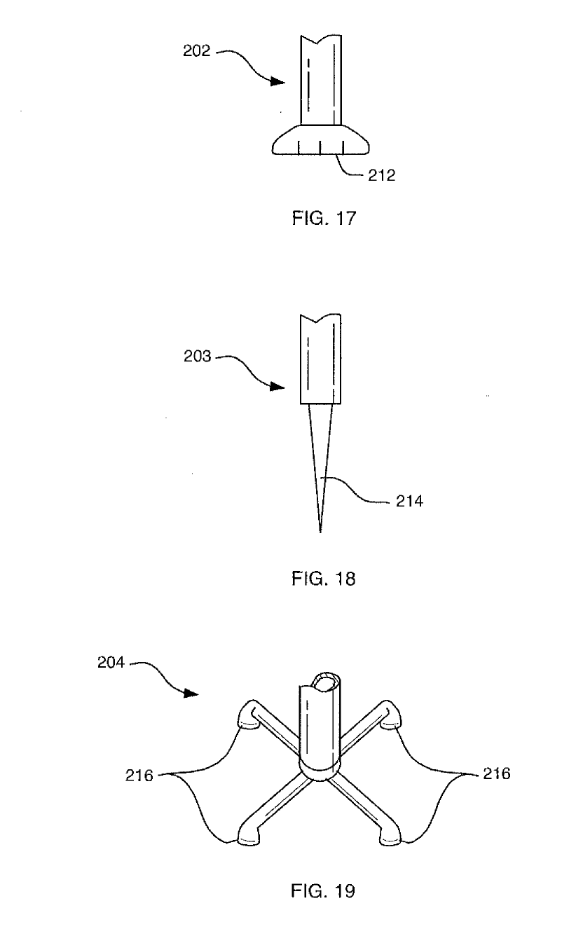

The ground contact member may have any one of a plurality of forms. In one example, the ground contact member is the footing 202 having surface gripping ground contact region 210 shown in FIG. 1 and ground contact region 212 in FIG. 17, for example. In another example, the ground contact member has a single, pointed ground contact region 214, such as ground contact member 203 shown in FIG. 18.

Further, while the ground contact members 202/203 shown in FIGS. 17 and 18 each has only a single ground contact region 212/214, it is to be understood that the ground contact member may include a plurality of contact regions. For example, ground contact member 204 of FIG. 19 includes four contact elements 216.

The ground contact member is not limited to the forms of the ground contact members shown in the FIGURES. The skilled artisan will recognize that the ground contact member may have any one of a variety of forms. The skilled artisan will further recognize that any one or more of the ground contact members shown may be used with either the apparatus 10 or the device 15.

When the apparatus 10 or the walking-assistive device 15 is being used, the ground contact member is able to contact any underlying surface on which the user may be present, including, but not limited to, interior flooring of all varieties, asphalt, concrete, dirt, sand, ice, snow, and the surface of an exercise device, such as the moving platform of a treadmill device, for example. The ground contact member may be selected to reduce the possibility that an individual will fall, slip or stumble while using any of the arrangements of the invention on a particular underlying surface. For example, the ground contact member 203 of FIG. 18 may be selected when the user of the apparatus 10 or the device 15 is to walk on an icy surface. The ground contact member also may include other features that have not already been shown or described with respect to the ground contact member to facilitate ground contact. For example, the ground contact member may include a high frictional surface at the contact region for improved contact between the apparatus 10 or the device 15 and the underlying surface.

Further, the ground contact member and/or the grip member may be selected based on the rehabilitative needs and/or physical ability of the user of the apparatus 10 or the walking-assistive device 15. For example, the footing 202 of FIG. 17 may be selected to be used in conjunction with the first grip member 101 when the user has reduced walking ability, and therefore needs to use the walking-assistive device 15 to walk on flat surfaces. As another example, the ground contact member 203 of FIG. 18 may be selected to be used in conjunction with the second grip member 104 where the user is to partake in a more strenuous activity than walking on a flat surface, such as hiking an inclined rocky terrain, for example.

It is to be further understood that any portion of the apparatus 10 may be fitted with a removable or integral receptacle or equivalent device for receiving and holding another part of the apparatus 10/walking-assistive device 15. For example, either or both of the rear pole members 23/24 may include a friction fit receptacle that snaps thereon for connecting a grip member, for example, to the rear pole member 23/24. The skilled artisan will recognize that other arrangements for convenient placement of and access to, optional grip members and/or ground contact members, are possible.

In summary, the apparatus 10 of the present invention is a multifunctional walking-assistance device. It includes a first embodiment in the form of a walker comprising one or more removable parts. The apparatus 10 is fully functional as a walker when all parts are joined together. When one or more of the removable parts are removed, the apparatus 10 ceases being available as a functioning walker and, instead, may be converted into a walking assistance device 15. The walking-assistive device 15 may be formed by taking a pole member of the apparatus 10 and applying a grip member thereto. The grip member selected may transform the pole member into either a cane or a trekking stick. An individual may thus acquire a single apparatus and use that apparatus to move from substantial walking assistance embodied in the walker form of the invention, to some assistance embodied in the cane form of the invention, and finally to minimal balance assistance when walking rigorously embodied in the trekking stick form of the invention. Through the present invention there is no longer a need to separately purchase a walker, a cane and a trekking stick, resulting in substantial cost savings and improved convenience for a user.

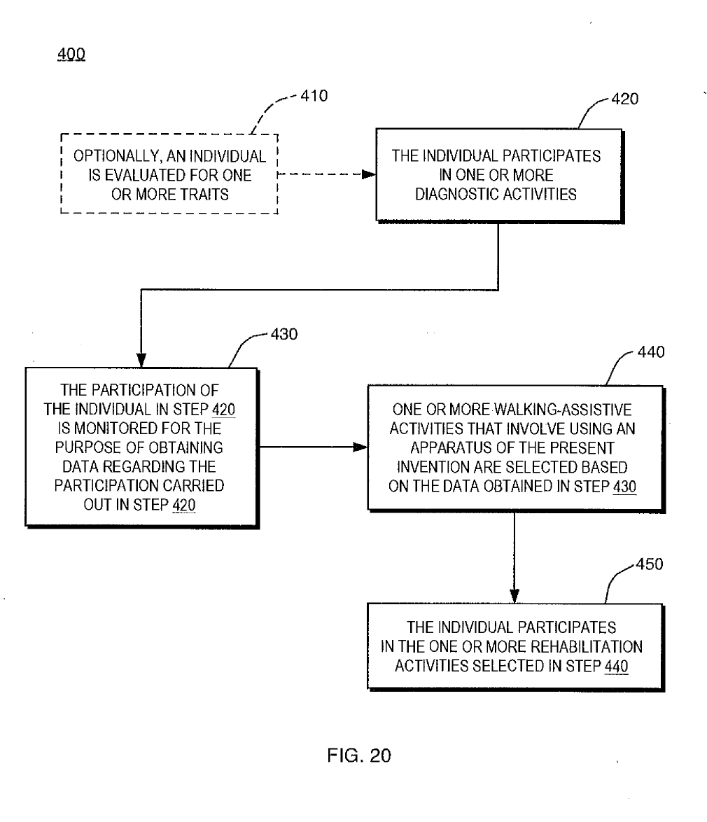

The method of the present invention includes one or more steps for using the apparatus 10 and walking-assistive device 15 for the purpose of enhancing a person's health. In one example, shown in FIG. 20, the method 400 includes the optional step of determining one or more traits of the individual, step 410. These traits may be, but are not limited to being, for example, those regarding baseline exercise limitations of the individual, physical limitations of the individual and/or nutritional intake by the individual.

In a second step of the method 400, step 420, the individual participates in one or more diagnostic activities that may or may not involve use of the apparatus of the present invention. Exemplary diagnostic activities include, but are not limited to being, for example, walking without using the apparatus 10 or walking-assistive device 15 and running while using the apparatus 10 or device 15 on a treadmill while the apparatus 10 or walking-assistive device 15 is connected to, or is in no way connected to, the treadmill.

In a third step of the method 400, step 430, the one or more diagnostic activities are monitored for the purpose of obtaining data regarding the individual's performance in the one or more diagnostic activities of step 420. This monitoring may be carried out in whole or in part by a person, such as by the individual who is the subject of the method or by a health care professional, for example. This monitoring also may be carried out in whole or in part by a machine, such as a computing device, an electrocardiograph machine or other types of tools, for example. “Data” include both objective and subjective data. Therefore, “data” include numerical values, such as numerical values that indicate heart rate, the individual's walking speed, or any other data of interest, and also includes less quantifiable, or unquantifiable, observations, such as “the individual began sweating profusely after several seconds” and “the individual walked normally for about five paces and then stumbled”, for example. Further, the data are storable and/or analyzable by computer. The computer may be any sort of computing system suitable for receiving information, running software on its one or more processors, and producing output of information, including, but not limited to, images and data that may be observed on a user interface.

In a fourth step of the method 400, step 440, one or more walking-assistive activities are selected based on the data of step 430, and in a fifth step of the method 400, step 450, the individual participates in the selected one or more walking-assistive activities of step 440. This participation in the walking-assistive activities of step 440 includes the use of the apparatus 10 or walking-assistive device 15. The selection of the one or more walking-assistive activities may be made by the individual who is the subject of the method, a health care professional, a machine, or by any combination thereof The walking may occur on a variety of surfaces, including those previously described herein. Therefore, the walking may occur on an exercise device, such as a powered treadmill, for example. Regardless of the exact nature of the walking-assistive activity selected, the apparatus 10 or walking-assistive device 15 can be arranged to optimally allow the individual to carry out that activity. For example, if the walking-assistive activity that is selected is trekking up an inclined terrain, a health care professional may elect to instruct the individual who is subject to the method to arrange the walking-assistive device 15 to include the grip member 102 of FIG. 14 and the pointed ground contact member 203 of FIG. 18 to carry out that activity.

It is to be understood that the data of step 430 may be used as the basis of selecting one or more ancillary activities for participation by the individual who is subject to the method that is meant to improve the overall wellness, and therefore not just the walking ability, of the individual. For example, a health care professional, such as a nutritionist, may direct the individual to perform the ancillary activity of changing his/her diet based on the data. As another example, a health care professional may direct the individual to perform a particular upper body strengthening program.

The apparatus and method of the present invention are more specifically described with reference to a specific Example; however, they are not to be construed as being limited thereto.

### EXAMPLE

A female individual of decreased physical condition undergoes knee replacement surgery on a knee that had been degenerating for three years. As a result, the individual is unable to walk without assistance, and therefore she has a “severe” walking disorder. The individual then becomes a rehabilitation patient (hereinafter, “Patient”) of a health care professional (hereinafter, “Physical Therapist”). Patient then partakes in a walking rehabilitation program, as directed by Physical Therapist according to the method of the present invention, as follows.

Physical Therapist directs Patient to use the device 15 of the present invention having the grip member 101 of FIG. 16A and the ground contact member 202 of FIG. 17 whenever Patient walks for four months, which specifically are the first four months (or “0-4 months”) of Patient's rehabilitation period. Physical Therapist further indicates that Patient is to only walk, and therefore is to not move by foot in any other manner, during this four-month period. It is the primary goal of Physical Therapist during this initial four-month period to have Patient regain her sense of balance. It is a secondary goal of Physical Therapist to have Patient gradually improve her ability to walk.

After abiding by Physical Therapist's instructions for these four months, Patient has a “somewhat less severe” walking disorder and has largely regained her sense of balance and, although she is still walking with difficulty, she is walking more normally than she was shortly after undergoing surgery. At this time, Physical Therapist instructs Patient to only walk for the next four months (i.e., months 4-8 of Patient's rehabilitation period), and to primarily use the device 15 of the present invention having the grip member 101 of FIG. 16A and the ground contact member 202 of FIG. 17 during this four month period. Physical Therapist further instructs Patient that she may use the device 15 having the grip member 101 of FIG. 16A and the ground contact member 204 of FIG. 19 whenever she feels too weak to walk with the device 15 having the grip member 101 of FIG. 16A and the ground contact member 202 of FIG. 17. It is the primary goal of Physical Therapist during this second four-month period to have Patient improve her ability to walk while becoming less dependent on the device 15.

On one day during this second four-month period, while aboard a train, Patient disassembles the device 15 and places all of its parts into a canvas carrying bag for easy storage in anticipation of a long ride on the train that will take her far away from her home. At the end of the train ride, Patient begins to reassemble the device 15 and, in doing so, she notices that the ground contact member 204 is severely worn and is in fact too worn to safely use. Patient then reaches into the canvas carrying bag and retrieves from it a second, new ground contact member 204, and includes this second, new ground contact member 204 in the reassembly of the device 15. (Because the ground contact member 204 is interchangeable, and therefore replaceable, Patient has avoided being stranded on the train without an operable device 15.)

After abiding by Physical Therapist's instructions throughout the second four-month period, Patient has a “moderate” walking disorder, which is less severe than was the somewhat less severe walking disorder experienced at the end of the first fourth months of rehabilitation. At this time, Physical Therapist has Patient use the device 15 having the grip member 101 of FIG. 16A and the ground contact member 202 of FIG. 17 to “walk about 50 feet and then turn around and walk back.” Physical Therapist then concludes that Patient has a “slight” walking disorder, which is less severe than the walking disorder experienced at the end of the second four-month period of rehabilitation. Physical Therapist then provides Patient with two of the devices 15 of the present invention having the grip member 104 of FIG. 14 and the ground contact member 202 of FIG. 17 (i.e., one device 15 for each of her hands) and asks her to extend her stride and walk more vigorously.

Physical Therapist directs Patient to use two of the devices 15 of the present invention having the grip member the grip member 104 of FIG. 14 and the ground contact member 202 of FIG. 17 to walk vigorously at least 15 minutes per day over the course of the next four months, to use the device 15 having the grip member 101 of FIG. 16A and the ground contact member 202 of FIG. 17 “whenever she feels she needs to use it”, and to not use the device 15 at all “whenever possible”.

After monitoring Patient weekly throughout the four-month period, Physical Therapist determines that Patient no longer has a walking disorder, and therefore declares that Patient has met the rehabilitative goals set for her regarding the walking disorder that manifested due to the surgery that Patient had undergone about 12 months prior. Thereafter, Patient and Physical Therapist may continue to engage in a wellness program, including the use of the device 15 with grip member 104 of FIG. 14 in addition to other exercise activities, dietary choices, or other ancillary activities to improve and maintain optimal health.

While the present invention has been described with particular reference to certain embodiments of the apparatus and method, it is to be understood that it includes all reasonable equivalents thereof as defined by the following appended claims.

What is claimed is:

1. A multifunctional apparatus for walking assistance, the apparatus comprising:
a. a first and second front pole member;
b. a first and second rear pole member;
c. a front connection member for connecting the front pole members to one another by friction fit or pressure connection on either side of the front connection member;
d. at least two side frame members for connecting the front pole members to the rear pole members, wherein two of the side frame members include a handle substantially at a right angle with respect to the axis of the front and rear pole members, and wherein when the front and rear pole members and the side frame members are joined together a walker is formed;
e. one set of first grip members and one set of second grip members, wherein each set includes one or more grip members distinct from the handle, and wherein one or both of the rear pole members includes means for removably connecting a selected grip member directly thereto, wherein the first grip members are arranged to provide stability and the second grip members are arranged to enable rigorous physical activity.

2. The apparatus of claim 1, wherein each of the one or more grip members in the set of first grip members includes a grip region joined to a grip body arranged such that when a grip member in the set of first grip members is removably connected to a rear pole member, the grip region is substantially at a right angle with respect to the axis of such pole member, and the grip body is substantially axially aligned with respect to the axis of such pole member.

3. The apparatus of claim 1, wherein each of the one or more grip members in the set of second grip members includes a grip region arranged such that when a grip member in the set of second grip members is removably connected to a rear pole member, the grip region is substantially axially aligned with respect to the axis of such pole member.

4. The apparatus of claim 1, wherein the front connection member for connecting the front pole members to one another is made from a transparent material connected to each front pole member.

5. The apparatus of claim 1, wherein the front connection member is configured to be in contact with a substantial portion of the front pole members through friction fit or pressure connection over mounting plates fitted onto the front pole members.

6. The apparatus of claim 1 wherein the lengths of at least the first rear pole member and the second rear pole member are adjustable.

7. The apparatus of claim 1 wherein each of the first rear pole member and the second rear pole member is formed by an upper shaft and a lower shaft, wherein the upper shaft is removably connectable to the lower shaft.

8. The apparatus of claim 1 further comprising a plurality of ground contact members, wherein each of the plurality of ground contact members has at least one ground contact region, and wherein the ground contact members are removably connectable to the end of each of the front and rear pole members.

9. The apparatus of claim 1 wherein the side frame members with the handles are integrally formed with the front pole members.

10. The apparatus of claim 1 wherein each of the front and rear pole members is formed by two or more shafts, and at least one of the two or more shafts is removably connectable to at least one other of the two or more shafts.

11. The apparatus of claim 2 wherein the grip region of the grip members of the first set includes or is formed as a soft covering.

12. The apparatus of claim 3 wherein the grip region of the grip members of the second set includes or is formed as a soft covering.

13. The apparatus of Claim I wherein the means for removably connecting the grip members is a spring pin, friction fit, or compatible male/female threading.

14. The apparatus of claim 1, wherein the apparatus may be partially or completely disassembled and/or folded for transportation or storage.

15. A multifunctional apparatus for walking assistance, the apparatus comprising:
a. one or more front pole members;
b. a first and second rear pole member; wherein either or both of the first and second rear pole member includes means for removably connecting a grip member directly thereto,
c. at least two side frame members for connecting the front pole member or members to the first and second rear pole member, wherein the side frame members each include a handle substantially at a right angle with respect to the axis of the rear pole members;
d. at least one first grip member distinct from the handle including a grip body and a grip region, wherein the grip body is substantially axially aligned with a primary axis of either of the first rear pole member and the second rear pole member when connected thereto, and wherein the grip region is substantially at a right angle with respect to a primary axis of either of the first rear pole member and the second rear pole member when connected thereto; and
e. at least one second grip member distinct from the handle including a grip region substantially axially aligned with a primary axis of either of the first rear pole member and the second rear pole member when connected thereto,
wherein either (i) a, b, and c can be combined to form a walker, or (ii) one or both of b can be combined with c and/or d to form at least one cane or trekking stick.

16. A method involving the use of a multifunctional apparatus to facilitate walking by an individual, the method comprising the steps of:
a. engaging the individual in one or more diagnostic activities;
b. obtaining data associated with the one or more diagnostic activities;
c. using the data to select one or more walking-improvement activities; and
d. selecting one or more walking-improvement activities to be performed by the individual, wherein the one or more walking-improvement activities are selected based on the data, and wherein the participation in the selected one or more walking-improvement activities includes the use of the apparatus.

17. The method of claim 16, wherein the apparatus includes a first and second front pole member, a first and second rear pole member, means for connecting the front pole members to one another, at least two side frame members for connecting the front pole members to the rear pole members, wherein when the front and rear pole members and the side frame members are joined together a walker is formed, and one set of first grip members and one set of second grip members, wherein each set includes one or more grip members distinct from the handle, and wherein one or both of the rear pole members includes means for connecting a selected grip member directly thereto, wherein the first grip members are arranged to provide stability and the second grip members are arranged to enable rigorous physical activity.

18. The method of claim 17 wherein the apparatus further includes a plurality of ground contact members, wherein each of the plurality of ground contact members has at least one ground contact region, and wherein the ground contact members are removably connectable to the end of each of the front and rear pole members.

19. The method of claim 16 further comprising the step of determining one or more traits of the individual.

20. The method of claim 20 wherein one or more of the step (b), the step (c), and the step of determining one or more traits of the individual is carried out by using a computer.
